(19) United States
(12) Patent Application Publication
(10) Pub. No.: US 2012/0239425 A1
(43) Pub. Date: Sep. 20, 2012

(54) Administering A Patient In A Hospital

(75) Inventors: Cynthia E. Barber-Mingo, Westford, MA (US); Angela Richards Jones, Durham, NC (US); Ruthie D. Lyle, Durham, NC (US)

(73) Assignee: INTERNATIONAL BUSINESS MACHINES CORPORATION, Armonk, NY (US)

(21) Appl. No.: 13/484,367

(22) Filed: May 31, 2012

Related U.S. Application Data
(63) Continuation of application No. 12/942,227, filed on Nov. 9, 2010.

(51) Int. Cl. G06Q 50/22

(52) U.S. Cl. 705/2

(57) ABSTRACT

Methods, systems, and computer program products are provided for administering a patient in a hospital. Embodiments include identifying, by a room optimizer module, upon the patient checking into the hospital, a set of patient attributes, each patient attribute describing an aspect of the health of the patient; selecting, by the room optimizer module, an optimized room for the patient in dependence upon the patient attributes and a set of room attributes of a plurality of rooms available, and indicating, by the room optimizer module, the selection of the optimized room to a hospital administrator.

### CROSS-REFERENCE TO RELATED APPLICATION

This application is a continuation application of and claims priority from U.S. patent application Ser. No. 12/942,227, filed on Nov. 9, 2010.

### BACKGROUND OF THE INVENTION

1. Field of the Invention

The field of the invention is data processing, or, more specifically, methods, apparatus, and products for administering a patient in a hospital.

2. Description Of Related Art

In hospitals, administering a patient can be a lengthy and time consuming process. An enormous amount of information related to the patient, room assignments, and scheduled procedures and maintenance must be processed by the hospital's computers. Hospital administrators use kiosks, handheld devices, and workstations to determine room availability and room assignments based on available space, staffing considerations, and cleaning schedules. However, when administering a patient, consideration of other factors besides the availability of the hospital's resources may be useful in increasing the success of the treatment of the patient. There is therefore an ongoing need for improvement in administering a patient in a hospital.

### SUMMARY OF THE INVENTION

Methods, systems, and computer program products are provided for administering a patient in a hospital. Embodiments include identifying, by a room optimizer module, upon the patient checking into the hospital, a set of patient attributes, each patient attribute describing an aspect of the health of the patient; and selecting, by the room optimizer module, an optimized room for the patient in dependence upon the patient attributes and a set of room attributes of a plurality of rooms available.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1A sets forth a network diagram of a system for administering a patient in a hospital according to embodiments of the present invention.

FIG. 1B sets forth a flow chart illustrating an exemplary method for selecting an optimized room for the patient according to embodiments of the present invention.

FIG. 2 sets forth a block diagram of automated computing machinery comprising an exemplary room selection system useful in administering a patient in a hospital according to embodiments of the present invention.

FIG. 3 sets forth a flow chart illustrating a further exemplary method for administering a patient in a hospital according to embodiments of the present invention.

FIG. 4 sets forth a flow chart illustrating a further exemplary method for administering a patient in a hospital according to embodiments of the present invention.

FIG. 5 sets forth a flow chart illustrating a further exemplary method for administering a patient in a hospital according to embodiments of the present invention.

### DETAILED DESCRIPTION OF EXEMPLARY EMBODIMENTS

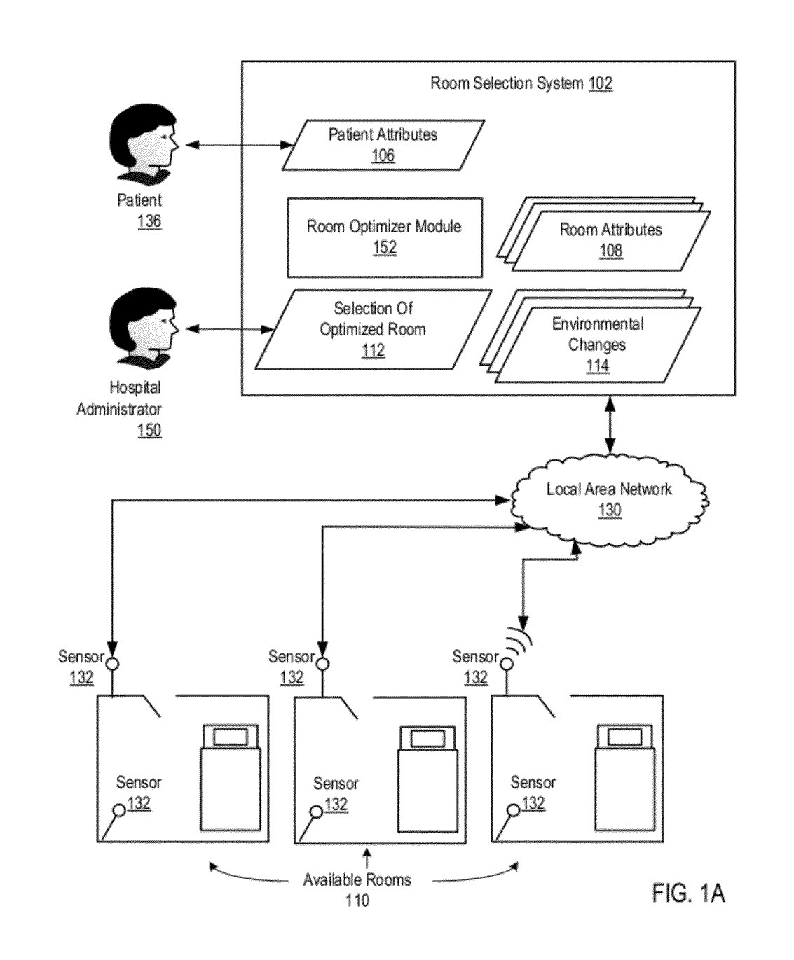

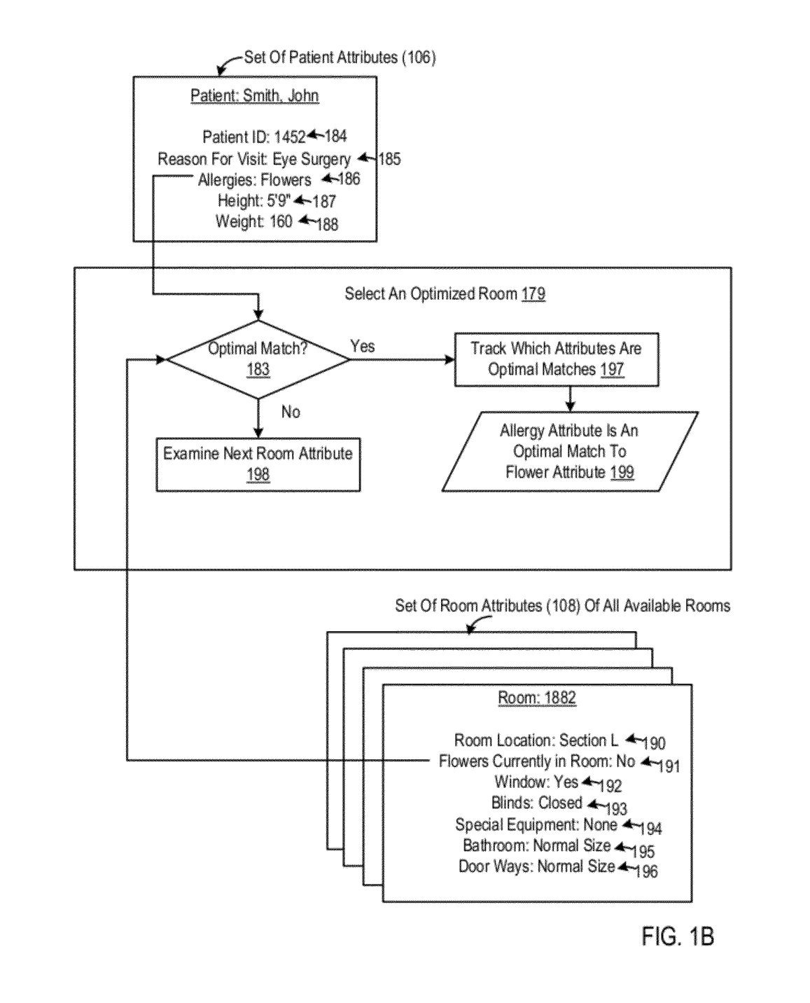

Exemplary methods, apparatus, and products for administering a patient in a hospital in accordance with the present invention are described with reference to the accompanying drawings, beginning with FIG. 1A. FIG. 1A sets forth a network diagram of a system for administering a patient in a hospital according to embodiments of the present invention. The system of FIG. 1A includes a plurality of available rooms (110) and a room selection system (102) that communicates with sensors (132) associated with the available rooms (110) over a local area network (130).

Each of the available rooms (110) has a corresponding set of room attributes (108). Room attributes (108) of FIG. 1A may indicate whether the room falls into a particular category based on the configuration of the bathroom, bed placement, room dimensions, presence of special utilities, absence of normal utilities, location of room in special wards of hospital, or other information corresponding to the room. For example, a room with enlarged doorways and bathrooms may have room attributes (108) that label the room as wheel chair accessible. As another example, if a room does not have a window, the room may be labeled in the room attributes (108) as being specifically for patients recovering from eye surgery or for light sensitive patients. Rooms that are capable of being sealed or secured may have a set of room attributes (108) designating the room as an infection controllable room or as a security controllable room. The room attributes (106) for each room are stored in the room selection system (102).

Each of the sensors (132) are configured to monitor the environment of one of the available rooms (110). If a sensor (132) determines that the environment of an available room (110) changes or potentially might change, the sensor (132) transmits the environmental change (114) to the room selection system (102). Environmental changes may include people, objects, and substances that would enter a room and therefore change the environment. The sensors (132) of FIG. 1A include any tool that can measure ambient environmental conditions or recognize objects. The sensors (132) of FIG. 1A may include radio frequency identification (RFID) tag readers, light sensors, temperature sensors, airborne particle sensors, forecast predictors, and so on. The sensors (132) of FIG. 1A may include pollen sensors that determine the levels of pollen in or outside the room. The sensors (132) may also include object recognition sensors that determine the presence of movement of objects, such as flowers. For example, in response to determining that the level of pollen in a room has risen, a sensor (132) may transmit the environmental change (114) to the room selection system (102). As another example, if the room sensor performs object recognition and determines that a visitor is carrying flowers and is preparing to enter a room, the room sensor (132) transmits the environmental change (114) to the room selection system (102). The room sensor (132) may use an RFID tag reader to read the tag on the flower to determine that the object about to enter the room is a bouquet of flowers. The sensors (132) of FIG. 1A may transmit the environmental change (114) through the local area network (132) by a wireless communication protocol, a wired communication protocol, or any know communication protocol.

The room selection system (102) of FIG. 1A includes a room optimizer module (152) that is configured to receive, store, aggregate, and compile all of the information associated with the available rooms (110), such as the room attributes (108) and the environmental changes (114). The room optimizer module (152) is also configured to identify, upon the patient (136) checking into a hospital, a set of patient attributes (106). Each patient attribute (106) describes an aspect of the health of the patient. The patient attributes (106) of FIG. 1A may indicate a specific medical condition, medications consumed by the patient (136), medications planned to be consumed by the patient, allergies of the patient, and so on. The patient attributes (106) may also indicate the reason the patient (136) is in the hospital, such as for eye surgery, allergy treatment, an infectious disease, and so on. The room selection system (102) of FIG. 1A may identify the patient attributes (106) by receiving patient information from a patient records database, a handheld patient administering device, or from a smart ID card attached to the patient that provides information about the patient's symptoms, current medications, and allergies.

In dependence upon the patient attributes (106), the room attributes, and the environmental changes (114) of the plurality of available rooms (108), the room optimizer module (152) of FIG. 1A selects an optimized room for the patient (136). The room selection system (102) may include a repository that maps environmental stimuli, illnesses, and associated risks to specific room conditions. For example, if the patient attributes (106) of the patient (136) indicate that the patient (136) suffers from allergies, the room optimizer module (152) may search through the room attributes (108) of the plurality of available rooms (110) to identify a room that has the lowest pollen count in or around the room. As another example, in response to patient attributes (106) indicating that the patient (136) is being treated in the hospital for eye surgery, the room optimizer module (152) may search for a room that has room attributes indicating the room is windowless or has specialty blinds. The room selection system (102) of FIG. 1A indicates the optimized room selection (112) to a hospital administrator (150). By determining the optimal room selection (112) for the patient (136) based on the room attributes (108), the environmental changes (108), and the patient attributes (106), the best available room for treating the patient (136) is selected, thus maximizing the resources of the hospital while achieving the best result for the patient (136).

The arrangement of servers and other devices making up the exemplary system illustrated in FIG. 1A are for explanation, not for limitation. Data processing systems useful according to various embodiments of the present invention may include additional servers, routers, other devices, and peer-to-peer architectures, not shown in FIG. 1A, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1A.

For further explanation, FIG. 1B sets forth a flow chart illustrating an example method of selecting an optimized room for the patient according to embodiments of the present invention. The method of FIG. 1B includes selecting (179) an optimized room for the patient. Selecting (179) an optimized room includes comparing (183) the set of patient attributes (106) to the set of room attributes (108) of all of the available rooms to determine which room is optimized for the patient. In the example of FIG. 1B comparing (183) the set of patient attributes (106) to the set of room attributes (108) is carried out by comparing a patient record with a set of room attribute records in a hospital database for an optimal match. The room selection system (102) of FIG. 1A may implement the method of FIG. 1B to determine which room to select for a patient.

The set of patient attributes (106) of FIG. 1B implemented as a record in a hospital database includes the following attributes and data values: “Patient ID: 1452” (184), “Reasons For Visit: Eye Surgery” (185), “Allergies: Flowers” (186), “Height: 5′9″” (187), and “Weight: 160” (188). The room attributes for room 1882 implemented as a record in a hospital database are illustrated as including the following attributes and data values: “Room Location: Section L” (190), “Flowers Currently in Room: No” (191), “Window: Yes” (192), “Blinds: Closed” (193), “Special Equipment: None” (194), “Bathroom: Normal Size” (195), “Door Ways: Normal Size” (196).

Comparing (183) the set of patient attributes (106) to the set of room attributes (108) may be carried out by comparing individual attributes of the set of patient attributes (106) with corresponding attributes in the set of room attributes (108), determining if the data in the individual patient attribute (184-188) corresponds with the data in the individual room attribute (190-196). If the individual patient attribute is an optimal match to a corresponding individual room attribute, the method of FIG. 1B includes tracking (197) which attributes (199) are optimal matches. Tracking (197) which attributes (199) are optimal matches may be carried out by storing which individual attributes (199) are optimal matches. If an individual patient attribute is not an optimal match to a corresponding individual room attribute, the method of FIG. 1B includes examining the next individual room attribute (198). For example, the patient attribute “Allergies: Flowers” (186) indicates that the patient is allergic to flowers and the patient attribute “Reason For Visit: Eye Surgery” (185) indicates that the patient is in the hospital for eye surgery. The room selection system (102) may indicate that room 1882 with room attribute “Blinds: Closed” (193) and room attribute “Flower Currently In Room: No” (191) is the optimal match for the patient. The method of FIG. 1B may continue until all of the patient attributes have been compared (183) with the individual room attributes (108). The room optimizer module (152) may indicate based on the comparisons, which room has the most corresponding individual room attributes that optimally match the patient attributes (106).

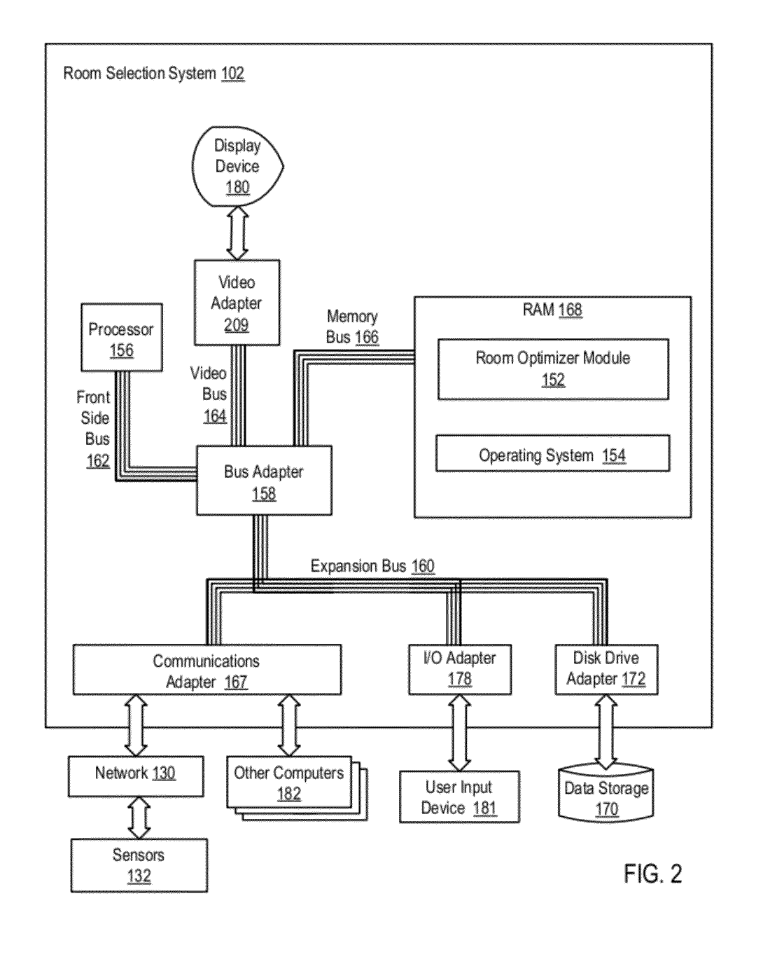

Administering a patient in a hospital in accordance with the present invention is generally implemented with computers, that is, with automated computing machinery. In the system of FIGS. 1A and B, for example, all the room selection system (102), the local area network (130), and the sensors (132) are implemented to some extent at least as computers. For further explanation, therefore, FIG. 2 sets forth a block diagram of automated computing machinery comprising an exemplary room selection system (102) useful in administering a patient in a hospital according to embodiments of the present invention. The room selection system (102) of FIG. 2 includes at least one computer processor (156) or ‘CPU’ as well as random access memory (168) (RAM') which is connected through a high speed memory bus (166) and bus adapter (158) to processor (156) and to other components of the room selection system (102).

Stored in RAM (168) is a room optimizer module (152) that includes computer program instructions for administering the patient in a hospital. The computer program instructions when executed by the processor (156) cause the processor (156) to identify, by the room optimizer module (152), upon the patient checking into the hospital, a set of patient attributes, each patient attribute describing an aspect of the health of the patient; in dependence upon the patient attributes and a set of room attributes of a plurality of available rooms, select, by the room optimizer module, an optimized room for the patient; and indicate, by the room optimizer module, the selection of the optimized room to a hospital administrator.

Also stored in RAM (168) is an operating system (154). Operating systems useful administering a patient in a hospital according to embodiments of the present invention include UNIX™, Linux™, Microsoft XP™, AIX™, IBM's i5/OS™ and others as will occur to those of skill in the art. The operating system (154) and the room optimizer module (152) in the example of FIG. 2 are shown in RAM (168), but many components of such software typically are stored in non-volatile memory also, such as, for example, on a disk drive (170).

The room selection system (102) of FIG. 2 includes disk drive adapter (172) coupled through expansion bus (160) and bus adapter (158) to processor (156) and other components of the room selection system (102). Disk drive adapter (172) connects non-volatile data storage to the room selection system (102) in the form of disk drive (170). Disk drive adapters useful in computers for administering a patient in a hospital according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The exemplary room selection system (102) of FIG. 2 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The exemplary room selection system (102) of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary room selection system (102) of FIG. 2 includes a communications adapter (167) for data communications with other computers (182) and for data communications with a data communications network (130) and the sensors (132). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for administering a patient in a hospital according to embodiments of the present invention include modems for wired dial-up communications, Ethernet (IEEE 802.3) adapters for wired data communications network communications, and 802.11 adapters for wireless data communications network communications.

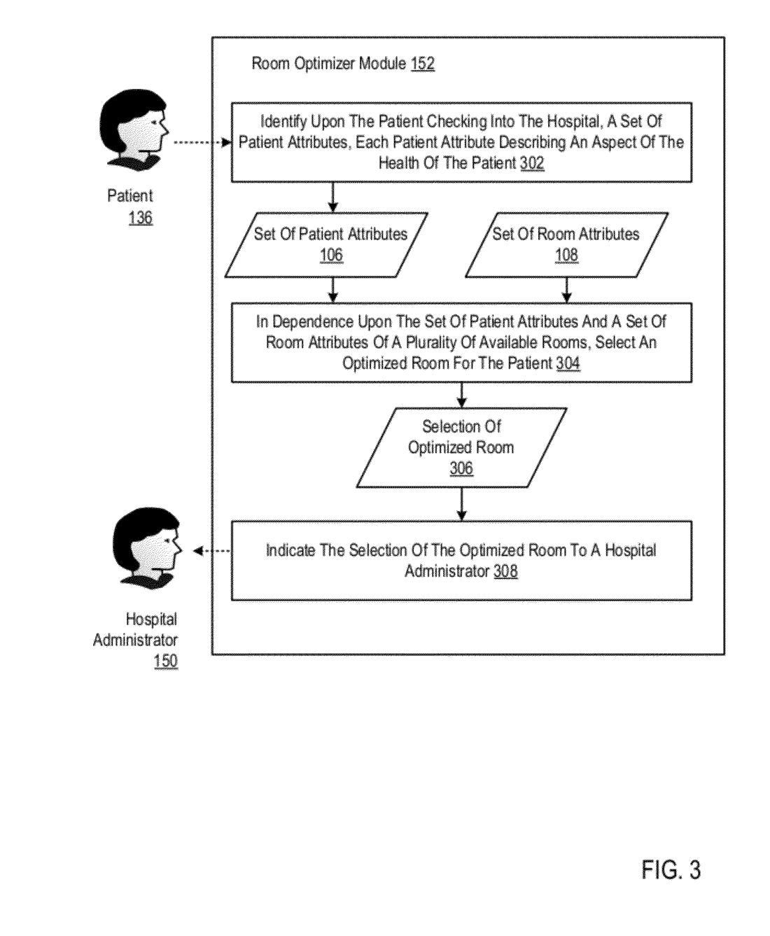

For further explanation, FIG. 3 sets forth a flow chart illustrating an exemplary method for administering a patient (136) in a hospital according to embodiments of the present invention. The method of FIG. 3 includes identifying (302), by a room optimizer module (152), upon the patient (136) checking into the hospital, a set of patient attributes (106), each patient attribute (136) describing an aspect of the health of the patient (136). Identifying (302) the set of patient attributes (106) may be carried out by establishing a connection with an radio frequency identification (RFID) tag that includes patient information; translating the data on the RFID tag into patient attributes (106), and storing the patient attributes in the room selection system (102). Identifying (302) the set of patient attributes (106) may also be carried out by establishing a connection with a patient database on a local area network or a wide area network, receiving patient information from the patient database, and storing the patient information in the room selection system (102). Identifying (302) the set of patient attributes (106) may also be carried out by the patient (136) filling out forms and the hospital administrator (150) entering the data from the forms in the room selection system (102).

The method of FIG. 3 also includes in dependence upon the patient attributes (106) and a set of room attributes (108) of a plurality of available rooms, selecting (304), by the room optimizer module (152), an optimized room (306) for the patient (136). Selecting (304) the optimized room (306) for the patient (136) may be carried out by comparing the set of patient attributes (106) with the entire set of room attributes (108) for all of the available rooms (110), identifying the closest match between the patient attributes (108) and a sub set of the room attributes (108) corresponding to a particular room, and storing the selection of the optimized room (306) in the room selection system (102).

The method of FIG. 3 includes indicating (308), by the room optimizer module (152), the selection (306) of the optimized room to a hospital administrator (150). Indicating (308) the selection (306) of the optimized room may be carried out by retrieving the selection of the optimized room (306) from the room selection system (102) and displaying to the hospital administrator (150), the selection of the optimized room (306) as a number or as an area on a map.

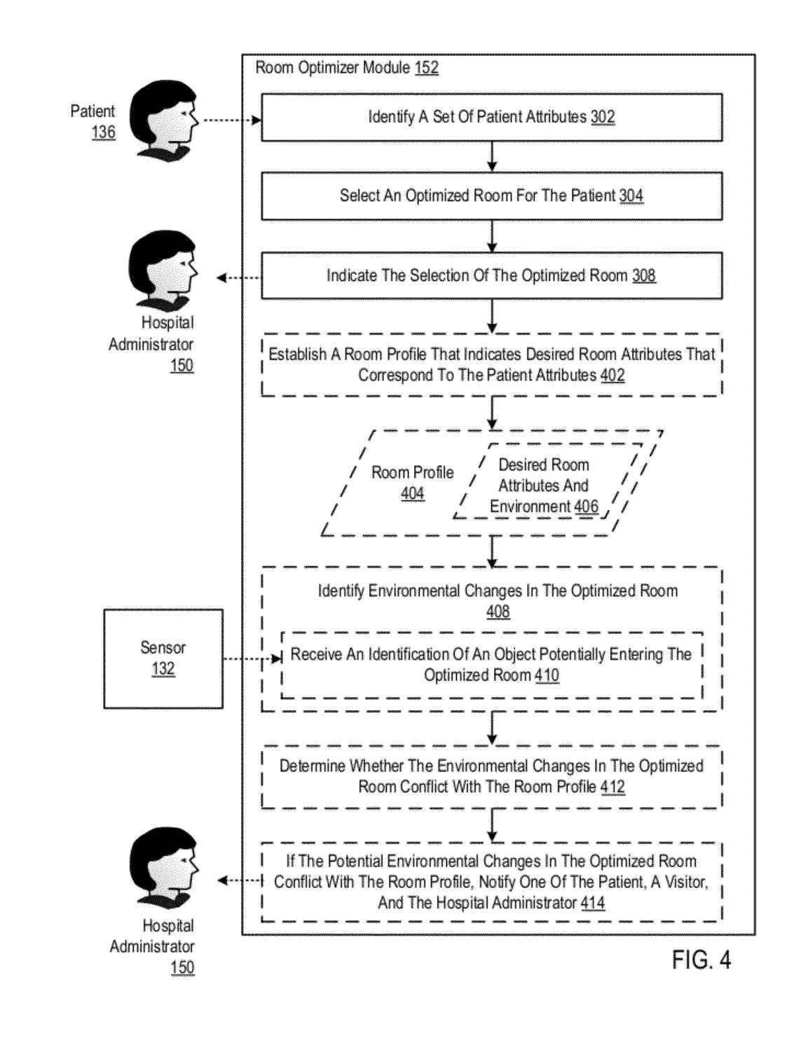

For further explanation, FIG. 4 sets forth a flow chart illustrating a further exemplary method for administering a patient in a hospital according to embodiments of the present invention. The method of FIG. 4 includes the following elements of the method of FIG. 3: identifying (302), by a room optimizer module (152), upon the patient (136) checking into the hospital, a set of patient attributes (106), each patient attribute (136) describing an aspect of the health of the patient (136); in dependence upon the patient attributes (106) and a set of room attributes (108) of a plurality of available rooms, selecting (304), by the room optimizer module (152), an optimized room (306) for the patient (136); and indicating (308), by the room optimizer module (152), the selection (306) of the optimized room to a hospital administrator (150).

The elements of FIG. 4 that differ from the method of FIG. 3 are illustrated in FIG. 4 with a dashed line. More particularly, those elements include: establishing (402), by the room optimizer module (152), a room profile (404) that indicates desired room attributes (406) that correspond to the patient attributes; identifying (408), by the room optimizer module (152), environmental changes in the optimized room; receiving (410) an identification of an object potentially entering the optimized room; determining (412), by the room optimizer module (152), whether the environmental changes in the optimized room conflict with the room profile; if the environmental changes in the optimized room conflict with the room profile, notifying (414) one of the patient (136), a visitor, and the hospital administer (150).

The method of FIG. 4 also includes establishing (402), by the room optimizer module (152), a room profile (404) that indicates desired room attributes (406) that correspond to the patient attributes. Establishing (402) the room profile (404) may be carried out by determining if a patient attribute corresponds with one of a plurality of desired room attributes and environment (406), storing the particular desired room attribute (406) in the room profile (404), and if there is a match, associating the room profile (404) with a patient. The desired room attributes and environment (406) of FIG. 4 may include specific configurations of the room that correspond with the aspects of the patient's health. For example, a patient that is sensitive to light, may have a desired room attribute of a windowless room or a desired environment of no light.

The method of FIG. 4 also includes identifying (408), by the room optimizer module (152), environmental changes in the optimized room. Identifying (408) the environmental changes may be carried out by establishing a connection with a sensor (132), receiving data indicating environmental changes from the sensor (132), associating the received data with a particular room, and comparing the data indicating environmental changes to previously stored environmental changes associated with the particular room. Identifying (408) the environmental change may include receiving (410) an identification of an object potentially entering the optimized room. For example, a light sensor in the optimized room may detect that the blinds are being opened. Receiving (410) the identification of an object potentially entering the optimized room may be carried out by performing object recognition at the sensor (132) and associating the identified object with environmental changes.

The method of FIG. 4 also includes determining (412), by the room optimizer module (152), whether the environmental changes in the optimized room conflict with the room profile. Determining (412) whether the environmental changes conflict with the room profile may be carried out by comparing the desired room attributes and environment (406) in the room profile with the environmental changes and storing the determination in the room selection system (102). For example, if the desired room attributes and environment (406) indicates that the room should be windowless or devoid of light, then opening the blinds would conflict with the particular room profile.

The method of FIG. 4 includes if the environmental changes in the optimized room conflict with the room profile, notifying (414) one of the patient (136), a visitor, and the hospital administer (150). Notifying (414) one of the patient (136), a visitor, and the hospital administer (150) may be carried out by transmitting data indicating a conflict from the room selection system (102) to a display inside or outside of the optimized room, transmitting a page to page notification system, transmitting data to a hospital console used by the hospital administrator. For example, if opening the blinds of a room conflict with the room profile, a display in the room may indicate a warning to close the blinds. In addition, an alert may be sent to the nurses' station to close the blinds in the particular room.

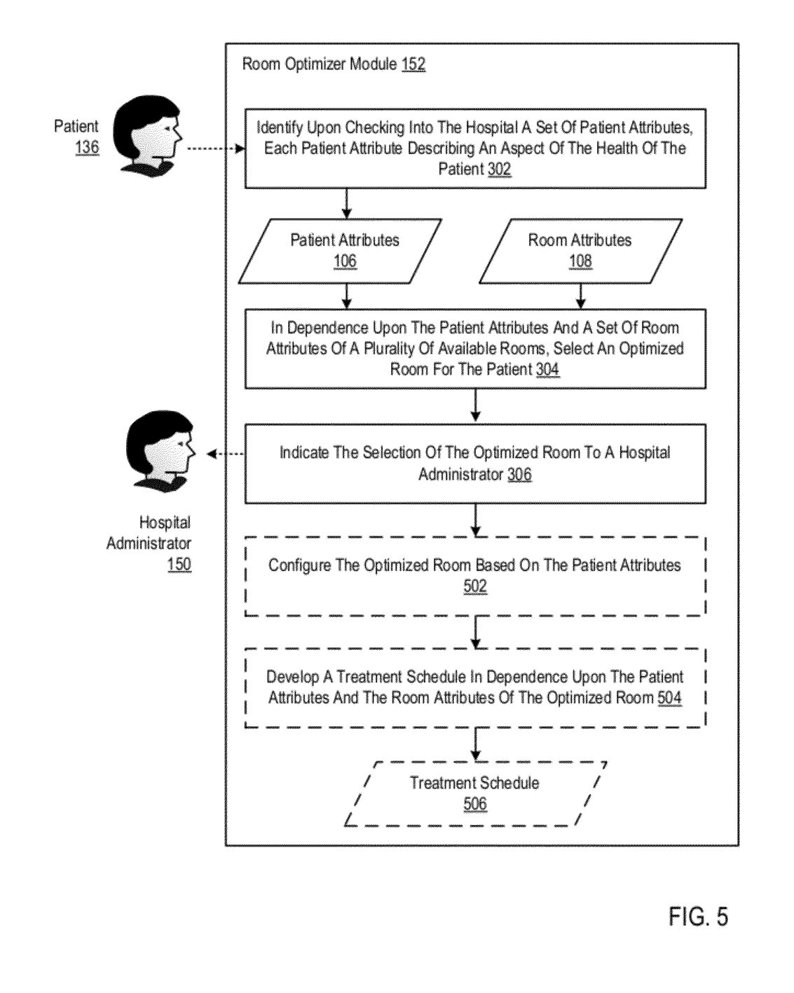

For further explanation, FIG. 5 sets forth a flow chart illustrating a further exemplary method for administering a patient in a hospital according to embodiments of the present invention. The method of FIG. 5 includes the following elements of the method of FIG. 3: identifying (302), by a room optimizer module (152), upon the patient (136) checking into the hospital, a set of patient attributes (106), each patient attribute (136) describing an aspect of the health of the patient (136); in dependence upon the patient attributes (106) and a set of room attributes (108) of a plurality of available rooms, selecting (304), by the room optimizer module (152), an optimized room (306) for the patient (136); and indicating (308), by the room optimizer module (152), the selection (306) of the optimized room to a hospital administrator (150).

The elements of FIG. 5 that differ from the method of FIG. 3 are illustrated in FIG. 5 with a dashed line. More particularly, those elements include: configuring (502), by the room optimizer module (152), the optimized room based on the patient attributes (106); and developing (504) a treatment schedule (506) in dependence upon the patient attributes (106) and the room attributes (108) of the optimized room.

The method of FIG. 5 also includes configuring (502), by the room optimizer module (152), the optimized room based on the patient attributes (106). Configuring the optimized room based on the patient attributes (106) may be carried out by identifying changes to make to the environment of the optimized room, identifying which department of the hospital is in charge of making the identified changes, and transmitting to the identified department a request to make the identified changes.

The method of FIG. 5 includes developing (504) a treatment schedule (506) in dependence upon the patient attributes (106) and the room attributes (108) of the optimized room. Developing (504) the treatment schedule (506) may be carried out by tracking scheduled maintenance and changes to the optimized room, determining the length of time to perform the scheduled maintenance and changes to the optimized room, determining the length of time to perform events associated with the treatment of the patient, and scheduling procedures related to the treatment of the patient during maintenance periods of the optimized room.

Exemplary embodiments of the present invention are described largely in the context of a fully functional computer system for administering a patient in a hospital. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A computer implemented method for administering a patient in a hospital, the method comprising:
identifying, by a room optimizer module, upon the patient checking into the hospital, a set of patient attributes, each patient attribute describing an aspect of the health of the patient;
in dependence upon the patient attributes and a set of room attributes of a plurality of available rooms, selecting, by the room optimizer module, an optimized room for the patient; and
indicating, by the room optimizer module, the selection of the optimized room to a hospital administrator.

2. The method of claim 1, wherein selecting an optimized room for a patient includes:
establishing, by the room optimizer module, a room profile for the patient, wherein the room profile indicates desired room attributes that correspond to the patient attributes; wherein the optimized room for the patient is the room that has the greatest number of desired room attributes.

3. The method of claim 1, further comprising:
identifying, by the room optimizer module, environmental changes in the optimized room;
determining, by the room optimizer module, whether the environmental changes in the optimized room conflict with the room profile;
if the environmental changes in the optimized room conflict with the room profile, notifying one of the patient, a visitor and a hospital administrator of the environmental change.

4. The method of claim 1, further comprising configuring the optimized room based on the patient attributes.

5. The method of claim 1, wherein identifying environmental changes in the optimized room further comprises receiving from a sensor an identification of an object potentially entering the optimized room.

6. The method of claim 1, wherein at least one of the patient attributes indicates an allergy of the patient.

7. The method of claim 1, further comprising developing a treatment schedule in dependence upon the patient attributes and the room attributes of the optimized room.

8-20. (canceled)
